(19) United States
(12) Patent Application Publication
(10) Pub. No.: US 2018/0143147 A1
(43) Pub. Date: May 24, 2018

(54) OPTICAL-COHERENCE-TOMOGRAPHY GUIDED ADDITIVE MANUFACTURING AND LASER ABLATION OF 3D-PRINTED PARTS

(71) Applicant: BOARD OF REGENTS, THE UNIVERSITY OF TEXAS SYSTEM, Austin, TX (US)

(72) Inventors: Thomas Milner, Austin, TX (US); Austin McElroy, Austin, TX (US); Joseph Beaman, Austin, TX (US); Scott Fish, Austin, TX (US)

(21) Appl. No.: 15/571,957

(22) PCT Filed: May 11, 2016
(86) PCT No.: PCT/US16/31880

§ 371 Date: Nov. 6, 2017

Related U.S. Application Data
(60) Provisional application No. 62/159,612, filed on May 11, 2015.

(51) Int. Cl. G01N 23/203; B29C 64/153; B22F 3/105; B29C 64/386; B33Y 10/00; B33Y 30/00; B33Y 50/02; B33Y 99/00

(52) U.S. Cl. CPC G01N 23/203; B29C 64/153; B22F 3/105; B33Y 99/00; B33Y 10/00; B33Y 30/00; B33Y 50/02; B29C 64/386

(57) ABSTRACT

An apparatus and method for detecting defects in an additive manufacturing process is provided. An example method may include depositing a first layer of material, depositing a second layer of material in at least partial contact with the first layer of material, and inducing a phase change between the first and second layers of material via an energy beam. Further, the method may include directing an electromagnetic radiation beam to at least a portion of a subsurface interface between the first and second layers, measuring radiation returned from the material, and based on the measured radiation, determining a location of a refractive index gradient within the material.

### RELATED APPLICATION

This application claims priority to, and the benefit of, U.S. Provisional Application No. 62/159,612, filed May 11, 2015, titled “Optical-Coherence-Tomography Guided Additive Manufacturing and Laser Ablation of 3D-Printed Part,” which is incorporated by reference herein in its entirety.

### BACKGROUND

Selective laser sintering (“SLS”) is an additive manufacturing technology. SLS can use a high power laser to manufacture a three-dimensional component (e.g., a part) in a layer-by-layer fashion from a powder such as plastic, metal, polymer, ceramic, composite materials, and the like.

For example, successive layers of powder can be dispensed onto a target surface (e.g., a build surface) and a directed energy beam can be scanned over the build surface to sinter the layers of powder to a previously sintered layer of powder. The directed energy beam can be a laser, which can be modulated and precisely directionally controlled. The scan pattern of the directed energy beam can be controlled using a representation such as a computer-aided design (“CAD”) drawing, for example, of the part to be built. In this way, the directed energy beam can be scanned and modulated such that it melts portions of the powder within the boundaries of a cross-section of the part to be formed for the layers. For example, SLS is described in detail in U.S. Pat. No. 5,053,090 to Beaman et al. and U.S. Pat. No. 4,938,816 to Beaman et al, each of which is incorporated by reference herein in its entirety.

Current additive manufacturing processes have limited feedback to correct layer defects that occur during manufacture. Certain current methods of “observing” the part as built involve infrared and visible imagery, which give information about features on the surface of the part while not providing information below the surface where layer to layer fusion is important to the part overall quality. Feedback-controlled in-situ fusion or subtractive processing can be complex in current 3D printing implementations.

Therefore, what are needed are devices, systems and methods that overcome challenges in the present art, some of which are described above.

### SUMMARY

Disclosed herein is an example method of detecting defects in an additive manufacturing process. The example method may include depositing a first layer of material, depositing a second layer of material in at least partial contact with the first layer of material, and inducing a phase change between the first and the second layer of material via an energy beam. Further, the method may include directing an electromagnetic radiation beam to at least a portion of a subsurface interface between the first and second layers, measuring radiation returned from the material, and based on the measured radiation, determining a location of a refractive index gradient within the material.

An example apparatus for producing a part via additive manufacturing is also disclosed herein. The apparatus may include a build surface, a print head configured to deposit material onto the build surface, and an energy source that directs energy into the deposited material. Further, the apparatus may include an optical source comprising an emitter for emitting an electromagnetic radiation beam and a receiver for receiving returned radiation, wherein the optical source directs the electromagnetic radiation beam toward the deposited material. The apparatus may include a controller that receives measurements of the returned radiation indicating the existence of refractive index gradients within the fused material.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a diagram of an example aspect of an additive manufacturing device having an optical coherence tomography portion.

FIG. 2 is a diagram of another example aspect of an additive manufacturing device having an optical coherence tomography portion.

FIG. 3 is a diagram of another example aspect of an additive manufacturing device having an optical coherence tomography portion.

FIG. 4 is a diagram showing an optical image of a sintered part generated via an Optical Coherence Tomography (OCT) system.

FIG. 5 is a diagram showing an optical image, generated via an OCT system, of the sintered part in FIG. 4 with a layer of powder on it.

FIG. 6 is a diagram showing an optical image, generated via an OCT system, of the powder only.

FIG. 7 is a diagram illustrating an apparatus for producing a part from a powder using a powder sintering process.

FIG. 8 is a diagram of an example computing device upon which embodiments of the disclosure may be implemented.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

According to one non-limiting aspect of the disclosure, an Optical Coherence Tomography (OCT) system can be added to any form of additive (or subtractive) manufacturing, i.e., selective laser sintering, extrusion, and the like. OCT is an imaging technique that uses broadband light to capture micrometer-resolution, three-dimensional images from within a media that may include for example optical scattering media. In a sintering system, OCT can interrogate a powder bed (which includes the sintered part regions and non-sintered powder) and evaluate each layer (both superficial and subsurface features) of the part as the sintering process progresses. The evaluation of the material may correspond to the powder bed before sintering, during sintering, or after sintering. With this information, the properties of the part at any layer as built can be estimated or adjustments can be made to the build process as the build proceeds. This adjustment facilitates the mitigation of defects or undesirable conditions using the OCT information by itself, or in conjunction with other measurements being made. Examples of such measurements include, but not limited to, visible and thermal image data of the powder bed surface.

OCT as a means of providing a feedback signal and guiding a processing beam can deliver high precision custom finishes in situ. Moreover, this disclosure contemplates and specifies optical systems that allow the combination of multiple light beams that can perform additive, feedback-control signals and subtractive functions in parallel and independently so that the speed of existing 3D printing processes are not compromised. Rather the capabilities can be expanded, and the quality can be improved.

OCT uses light with a multiplicity of emission wavelengths and enables not only a view of the visible surface of the build process, but a penetrating 3D view through a built layer to evaluate sub-surface properties such as layer to layer bonding. To this end, the OCT system, in some embodiments, generates a beam with at least two distinct optical frequencies.

Adding OCT monitoring and control to a 3D printing process can be a cost-effective, non-contact way to monitor the 3D printing process and provide feedback on, among other things, surface height, layer thickness, roughness, homogeneity, layer fusing energy requirements, and layer fusing phase state changes.

Additionally, an ablation laser can be included that may provide high aspect material removal and may be combined with OCT. Moreover, any of these three laser beams may operate in parallel but scan different locations on the 3D printed part.

OCT imaging can be integrated to a 3D printer for the purpose of guiding an ablation laser that will target a printed part. The ablation laser may produce a spatially chirped beam as described in US patent application (8669488 B2), entitled “Spatially chirped pulses for femtosecond ablation through transparent materials,”, which is incorporated by reference herein in its entirety. The use of a spatially chirped beam provides control over the spatial-temporal focusing of the beam and may be used to create high aspect ratio surfaces in a target material.

Additionally, a system is disclosed that can combine multiple beams in a 3D printing operation. This operation can perform, in addition to the traditional printing operation (e.g., laser sintering), depth resolved diagnostics based on OCT and correct defects, e.g., using laser ablation. Moreover the optics of these systems may be designed such that the scanning beams for these laser beams can include a single scanner or multiple scanners (e.g., that are separated, but having beams combined). By using distinct scanners, in some of embodiments, the processes using these beams (e.g., sintering and ablation processes) may be completed in parallel (at the same time) but at different spatial locations. In this configuration, a single 3D printing system may be realized that combines additive, monitoring and subtractive processes that may be performed in parallel (at the same time) at different locations on the 3D printed part. Moreover, a non-scanning OCT system may be used in combination with a scanning additive and/or scanning subtractive system.

A refractive index gradient, as used herein, refers to any gradient in a material that may exist natively or be created by passing an energy beam through a portion of the 3D printed part. In some example embodiments, the energy beam is a light beam (i.e., a beam of electromagnetic radiation) that penetrates the 3D printed part to a particular depth. In other embodiments, the energy beam is the sintering beam or the ablation or cutting beam. A refractive index gradient may be used to detect, for example, whether voids, imperfections, boundaries or density gradients may exist within certain layers (e.g., the sub-surface layers) of the 3D printed part.

In one exemplary aspect of the disclosure, OCT using a broadband light source can be used in, some, or all stages of additive printing, in particular: (1) to monitor the thickness of each layer of material before the fusing process; (2) to monitor the phase change of the material before, during, and after fusing; (3) and based on monitored signals, to modify laser dosimetry (e.g., power, pulse duration, pulse energy, laser emission wavelength); (4) to evaluate the surface roughness of the material before, after, and during the fusing process; (5) to evaluate the dimensions of the surface before, after, and during fusing; (6) to compare the manufactured part to digital source representations (for example, those in Computer Aided Design files) for quality measurements and validation in situ; (7) to detect and localize voids, density gradients, material boundaries or other defects in the part as each layer is added and fused (with potential for remediating such voids and defects in-situ); and (8) to monitor the 3D printing environment to adjust process parameters for desired part fabrication characteristics.

In another exemplary aspect of the disclosure, the broadband OCT beam can either be collinear with the fusing process (i.e., collinear with a laser or other energy beam) or offset therewith. When used with additive manufacturing with a print head (i.e., in an extrusion process), the OCT system can be integrated into the print head or offset therewith. This integration can allow for the in situ monitoring of the additive manufacturing process and allow for the measuring of the part as each layer is added and fused. The monitoring process may be completed without disturbing the fusion process. In addition, the monitored signal can be used to modify the laser dosimetry for the additive manufacturing process. Defects, density gradients, or material boundaries can be detected and corrected before new layers are added to increase part yield and maintain design specifications. A variety of signals can be derived from the OCT light signal including, for example, the backscattered light intensity, the Doppler shift of a moving interface (phase boundary), the scattering strength of material being fused, the birefringence of the material, the spectral characteristics in the backscattered light and the geometric dimensions of the fused material.

In yet another exemplary aspect of the disclosure, the derived signals from the broadband OCT beam can be used in a feedback mode to improve the control of the manufacturing process. For example, an OCT system may be used to monitor the thickness of a powder layer. The monitored thickness data may be used to set the incident laser dosimetry applied to that particular spatial location, the scan speed of galvanometers used in the process, the next layer thickness, the chamber heat control, and the like. Part dimensions can also be measured in situ and compared against a reference digital description of the part to provide quality and verification certificates for fabrication conditions during the build.

Additional measurements could be made on the part dimensions and compared against reference digital descriptions of the part (for instance: Computer Aided Design or CAD data) to provide quality metrics. For example, part tolerances and an ISO certificate could be provided to the FAA for a 3D printed avionic part immediately after the part comes off the printer.

In yet another exemplary aspect of the disclosure, recorded signals from an OCT system may be used to facilitate removal of “stair step” striations that are inherent in current 3D printing modalities and to aid in creating finishing for surfaces of a printed part, including polishing, dimpling, and the like. During the printing process, ablation can be performed to trim build layers to a resolution finer than that of the additive printing process. For example, if a printer has a minimum width or height resolution of 100 micrometers, laser trimming can be used to reduce the produced feature resolution of the printer to the micron or submicron level. During printing, an ablation laser can be used to smooth the surface and remove particles after each layer. The ablation laser can be used to correct defects.

The finish of a 3D printed part may require additional steps to meet manufacturing and quality guidelines. An ablation laser (possibly including a spatial chirp as described by Squier et al.) guided by an OCT system can remove material in situ to meet surface specifications. The ablation laser can be used to remove the striations of a 3D printed part and to finish a surface to specified surface smoothness standards. The ablation laser can also be used to trim the printed part in situ to increase the minimum resolution of the 3D printer. The ablation laser can also be used to finish layers as described above. For example, if a powder is more evenly distributed on a smooth surface, the previous surface could be smoothed using the ablation laser. Parts may also be “roughed” using the ablation laser if desired. If a powder adheres better to a rougher surface, the ablation laser could dimple the previous layer.

In yet another exemplary aspect of the disclosure, the scanning system for the sintering and ablation lasers can be separate and distinct from each other while the ablation and sintering beams co-propagate. By employing separate scanning systems to produce the ablation and sintering beams, ablation and sintering processes may be performed in parallel but independently at different spatial locations. Thus, the ablation processes can be performed simultaneously with the sintering and broadband OCT light source without impacting the speed of the 3D printing process.

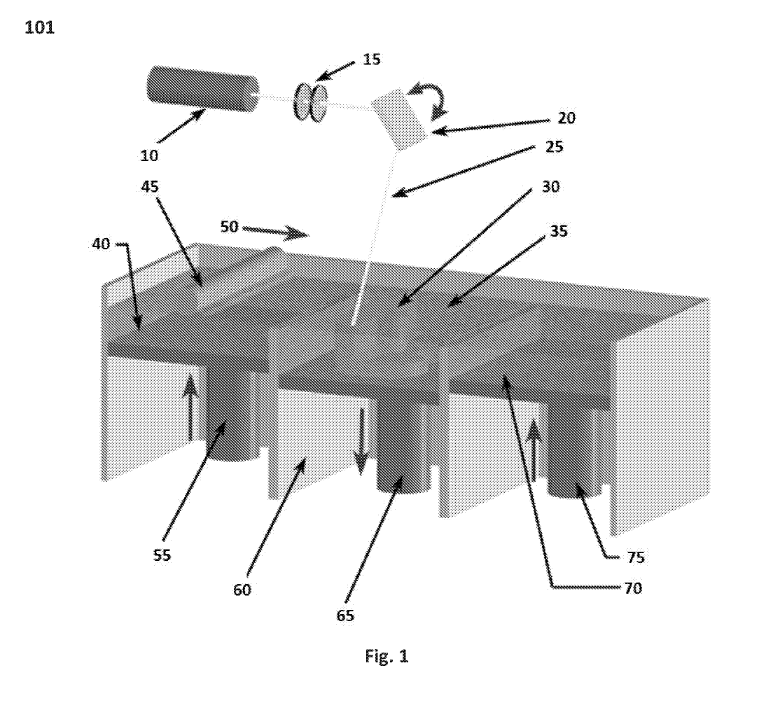

FIG. 1 shows an example laser sintering system 101. In this system, powder is supplied by pistons 55 and 75, which each pushes upward slightly to expose feed powder 40 and 70 to a roller/spreader 45, which then sweeps the exposed powder 40, 70 across a build surface 35 for each layer of the build. As shown in FIG. 1, the roller/spreader 45 is moving the powder from the supply side 40 in the direction shown by arrow 50 to generate a uniform powder layer. A laser 10 generates a beam, which is focused at a sintering point using optics 15 and directed using a moving mirror set 20 to selectively melt (without liquefying) only the portion of the powder layer that will become part of the desired 3D-part 30 in that layer. Beam 25 shows this moving beam in one part of the part layer scan. When the layer, scanned with the laser, is completed for a given direction, a part build piston 65 is adjusted (e.g., lowered one layer thickness) to prepare for the powder spreading from the other supply side. The process is repeated on a layer-by-layer basis until the full height of the build is completed.

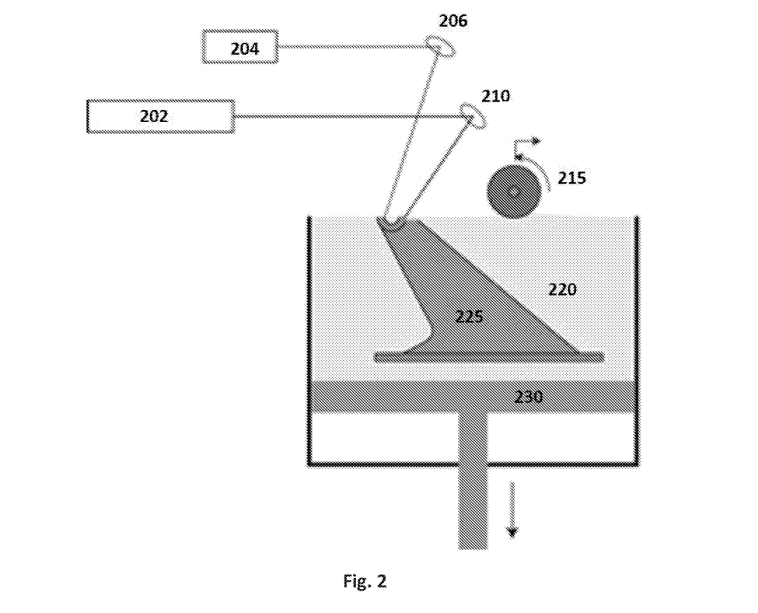

FIG. 2 shows one method of integrating Optical Coherence Tomography with the Selective Laser Sintering Process. In this figure, the laser sintering system 101 (also referred to as a laser scanning system) is simplified to a representation of the laser 10 (shown here as 204) and the focusing/steering optics 15 and 20 (shown here as 206). The OCT system is represented as a separate broadband light source 202 which may be for example a tunable laser or broadband emitter and a focusing/delivering/receiving optics 210. The roller/spreader 215 is shown and a sample 3D part 225, in partial build, is shown surrounded by unscanned/unmelted powder 220. The part build piston 230 is shown lowering incrementally for each layer of the build process.

The selection criteria for the wavelength of the OCT beam, in some embodiments, is that the attenuation (incorporating both scattering and absorption) length of the OCT light in the powder layer and/or sintered material should be of the same order of magnitude or less than the thickness of the powder layer or the interrogation depth in the sintered material.

When used, or combined, with an ablation laser system, the wavelength selection for each mechanism may depend on the type of ablation. For example, for non-plasma ablation (wherein there is light absorption by the material to cause a “blow-off” of the material), the wavelength of the ablation laser may be selected to be absorbed by the sintered material. In addition, the wavelength is selected such that the attenuation length of the laser light in the sintered material is nearly equivalent to the amount of material that is to be removed.

As another example, for plasma ablation, e.g., with a pico-second or femtosecond pulse duration, the wavelength may be less important and, thus, the selection may be according to the plasma ablation that is produced in the sintered material.

In some embodiments, the selection of wavelength may use techniques similar to those in subtractive laser processing.

In some embodiments, the optics for the OCT system and the Selective Laser Sintering system integrates the two systems to provide a collinear beam.

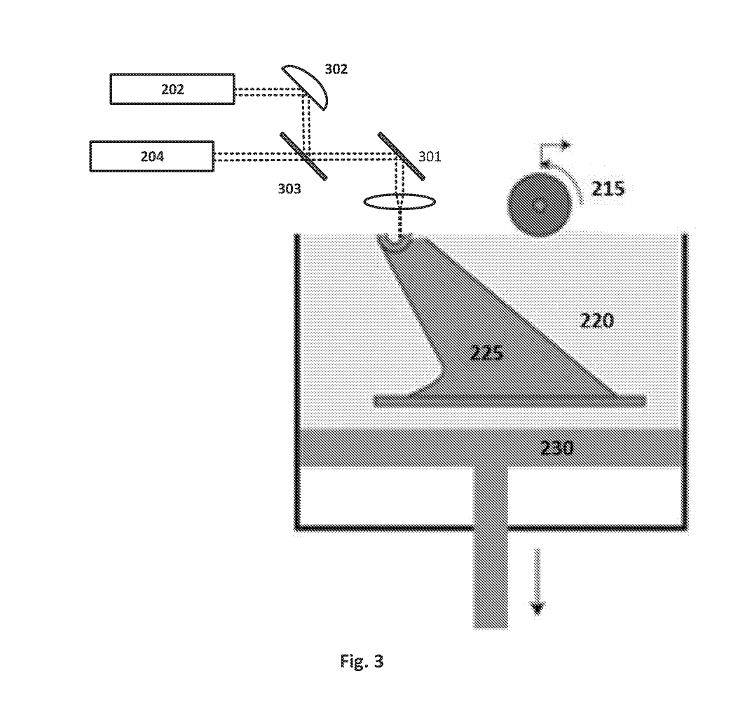

FIG. 3 shows another method of integrating Optical Coherence Tomography with the Selective Laser Sintering Process. In this figure, the laser 204 of the laser sintering system 101 generates a beam which is reflected and directed, by mirror 301 and a focal lens, onto a sintering area on the part 225. The light source 202 generates a second beam that is directed, via mirror 302, to a dichroic lens 303, which combines the beam generated by the laser 204 with the beam generated by the light source 202. The combined beam is directed to the sintering point on the part 225. In some embodiments, light reflecting from the part 225 are directed back to the mirror 301 to a detector (not shown) in the OCT system.

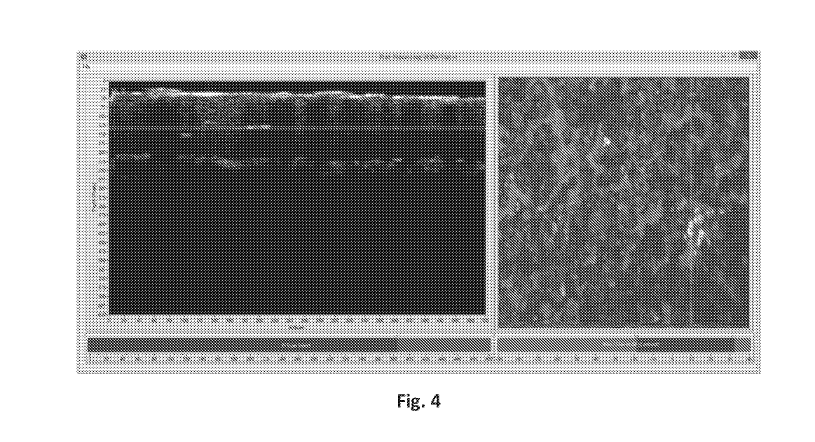

FIG. 4 discloses two views of an OCT tomographic image of a sintered nylon part. The left image is a slice (B-scan) into the sintered nylon part where horizontal lines are drawn to indicate depth location of possible defects. Bright features between the two lines indicate possible defects corresponding to refractive index gradients. These horizontal lines in the B-scan image (left) indicate upper and lower depths over which an en face view is produced of the sintered nylon part, which can be seen on the right image. Features in the en face image on the right image indicate sub-surface regions in the sintered nylon part at depths between the two horizontal lines that have increased refractive index gradients and may correspond to defects in the sintered nylon part. The indicated vertical line on the right image corresponds to the location of the slice (B-scan) that is depicted on the left image.

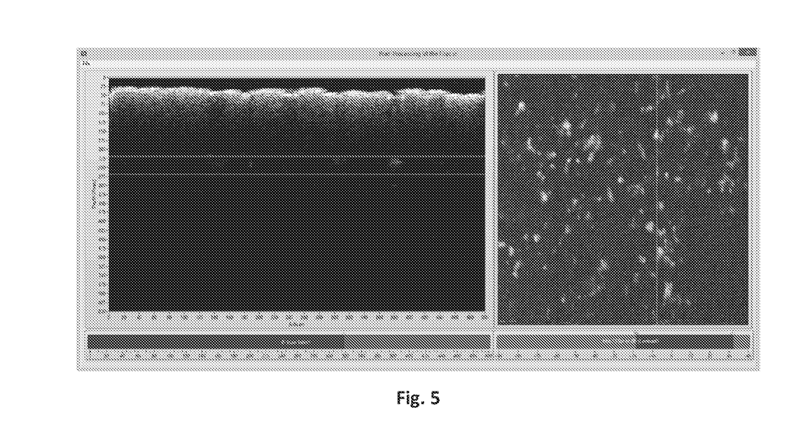

FIG. 5 discloses two views of an OCT tomographic image of a sintered nylon part with an overlying thin layer of un-sintered nylon powder. The left image is a slice (B-scan) into the sintered nylon part with an overlying un-sintered nylon powder where horizontal lines are drawn to indicate possible defects in depth. These horizontal lines in the B-scan image (left) indicate upper and lower depths over which an en-face view is produced of the sintered nylon part and which is presented on the right image. Features in the en face image on the right image indicate regions in the sintered nylon part at depths between the two horizontal lines that have increased refractive index gradients and that may correspond to defects in the part. This result demonstrates that locations of defects can be detected in a sintered nylon part in the presence of an overlying layer of powder. The indicated vertical line on the right image corresponds to the location of the slice (B-scan) that is depicted in the left image.

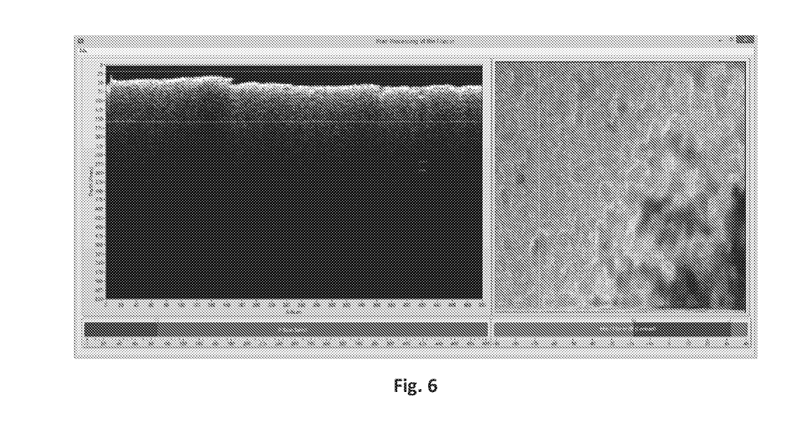

FIG. 6 discloses two views of an OCT tomographic image of un-sintered nylon powder. The left image is a slice (B-scan) of the un-sintered nylon powder. Bright regions in the OCT B-Scan image indicate locations of large refractive index gradients formed by interfaces between the gaseous atmosphere and the nylon powder granules. The B-Scan image on the left indicates surface smoothness information about the nylon powder layer prior to sintering. Horizontal lines in the B-scan image (left) indicate upper and lower depths over which an en-face view is produced of the un-sintered nylon powder and which is presented on the right image. Brightness variations in the en face view on the right image indicate the variation in strength of the refractive index gradients between the two horizontal lines in the B-scan image on the left. The indicated vertical line on the right image corresponds to the location of the slice (B-scan) that is depicted in the left image.

According to one non-limiting aspect of the disclosure, the SLS system can use a pulsed laser. The finished part density may depend on peak laser pulsed power used, rather than the laser pulse duration. The SLS machine can preheat the bulk powder material in the powder bed near the melting point of the powder to reduce the energy to be added by the laser to raise the temperature of the selected regions to the way to the melting temperature.

Additionally, the SLS machine can use single-component powder, such as direct metal laser sintering. Powders can be commonly produced by ball milling. SLS machines can use two-component powders, typically either coated powder or a powder mixture. In single-component powders, the laser melts only the outer surface of the particles (surface melting), fusing the solid non-melted cores to each other and to the previous layer.

SLS can produce parts from a relatively wide range of commercially available powder materials. These include polymers such as nylon (neat, glass-filled, or with other fillers) or polystyrene, metals including steel, titanium, alloy mixtures, and composites and green sand. The physical process can be full melting, partial melting, or liquid-phase sintering.

According to another non-limiting aspect of the disclosure, laser ablation can refer to the process of removing material from a solid (or occasionally liquid) surface by irradiating it with a laser beam. At low laser flux, the material can be heated by the absorbed laser energy and evaporates or sublimates. At high laser flux, the material can be converted to a plasma. Laser ablation can refer to removing material with a pulsed laser. However, it is possible to ablate material with a continuous wave laser beam if the laser intensity is high enough.

Additionally, the laser used for the SLS may be configured to be continuous wave operation mode. This is because in some applications of the SLS lasers may output a beam whose output power is constant over time. Such a laser may be referred to as continuous wave (CW). These lasers may have cavities that can be configured to lase in several longitudinal modes at the same time, and beats between the slightly different optical frequencies of those oscillations to produce amplitude variations on time scales shorter than the round-trip time (the reciprocal of the frequency spacing between modes).

Additionally, the pulsed operation of lasers may refer to any laser operation not classified as continuous wave output such that the output power appears in pulses of some duration at some repetition rate. Some lasers may be pulsed simply because they cannot be run in continuous mode.

Moreover, the production of pulses having as large an energy as possible may be desirable. Since the pulse energy can be equal to the average power divided by the repetition rate, this goal can sometimes be satisfied by lowering the rate of pulses so that more energy can be built up in between pulses. In laser ablation for example, a small volume of material at the surface of a work piece can be evaporated if it is heated in a very short time, whereas supplying the energy gradually would allow for the heat to be absorbed into the bulk of the piece, but not attaining a sufficiently high temperature at a particular point.

In other aspects of the disclosure, the peak pulse power (rather than the energy in the pulse) may be desirable, in order, for example, to obtain nonlinear output effects. For a given pulse energy, this may involve creating pulses of the shortest possible duration utilizing techniques such as Q-switching.

Furthermore, other kinds of pulsed laser operation may be desired. For example, single pulsed (normal mode) lasers can be used, where they generally have pulse durations of a few hundred microseconds to a few milliseconds. This mode of operation may sometimes referred to as long pulse or normal mode.

Another example use may be with single pulsed q-switched lasers that can be the result of an intracavity delay (Q-switch cell), which allows the laser media to store a maximum of potential energy. Then, under optimum gain conditions, emission occurs in single pulses; typically of 10⁻⁸ second time domain. These pulses may have high peak powers often in the range from 10⁶ to 10⁹ Watts peak.

Another example use may be with repetitively pulsed or scanning lasers which involve the operation of pulsed laser performance operating at a fixed (or variable) pulse rates. This may range from a few pulses per second to as high as 20,000 pulses per second. The direction of a CW laser can be scanned rapidly using optical scanning systems to produce the equivalent of a repetitively pulsed output at a given location.

Another example use may be with mode locked lasers that operate as a result of the resonant modes of an optical cavity. This can affect the characteristics of the output beam. When the phases of different frequency modes are synchronized, i.e., “locked together,” the different modes will interfere with one another to generate a beat effect. The result can be a laser output which can be observed as regularly spaced pulsations. Lasers operating in this mode-locked fashion can produce a train of regularly spaced pulses, each having a duration of 10⁻¹⁵ (femto) to 10⁻¹² (pico) sec. These pulses will have peak powers often in the range from 10¹² Watts peak.

Additionally, point defects can be defined as material defects that occur only at or around a single lattice point. Moreover, vacancy defects can be defined as lattice sites which would be occupied in a perfect crystal, but are vacant. A vacancy (or pair of vacancies in an ionic solid) can be called a Schottky defect in the art.

Additionally, interstitial defects can be defined as atoms that occupy a site in the crystal structure at which there is usually not an atom. Moreover, a nearby pair of a vacancy and an interstitial may be known as a Frenkel defect or Frenkel pair in the art. This can be caused when an ion moves into an interstitial site and creates a vacancy.

Additionally, defects may comprise an impurity, where an atom is incorporated at a regular atomic site in the crystal structure, known as a substitutional defect in the art. In some cases where the radius of the substitutional atom (ion) is substantially smaller than that of the atom (ion) it is replacing, its equilibrium position can be shifted away from the lattice site. These types of substitutional defects are often referred to as off-center ions. There are two different types of substitutional defects commonly identified in the art: Isovalent substitution and aliovalent substitution. Isovalent substitution is where the ion that is substituting the original ion is of the same oxidation state as the ion it is replacing. Aliovalent substitution is where the ion that is substituting the original ion is of a different oxidation state as the ion it is replacing. Aliovalent substitutions change the overall charge within the ionic compound, but the ionic compound must be neutral. One of the metals can be partially or fully oxidized or reduced, or ion vacancies can be created.

Additionally, defects may comprise anti-site defects. These defects can occur in an ordered alloy or compound when atoms of different type exchange positions. For example, some alloys have a regular structure in which every other atom is a different species; for illustration assume that type A atoms sit on the corners of a cubic lattice, and type B atoms sit in the center of the cubes. If one cube has an A atom at its center, the atom is on a site usually occupied by a B atom, and is thus an anti-site defect.

Furthermore, defects may comprise topological defects, which can be defined as regions in a crystal where the normal chemical bonding environment is topologically different from the surroundings.

Moreover, defects can also be defined in amorphous solids based on empty or densely packed local atomic neighborhoods, and the properties of such ‘defects’ can be shown to be similar to normal vacancies and interstitials in crystals.

Additionally, defects may comprise dislocations. Dislocations can be linear defects around which some of the atoms of the crystal lattice are misaligned. There are two basic types of dislocations commonly known in the art, the edge dislocation and the screw dislocation. “Mixed” dislocations, combining aspects of both types, are also possible.

Edge dislocations can be caused by the termination of a plane of atoms in the middle of a crystal. In such a case, the adjacent planes are not straight, but instead bend around the edge of the terminating plane so that the crystal structure is perfectly ordered on either side.

The screw dislocation comprises a structure in which a helical path is traced around the linear defect (dislocation line) by the atomic planes of atoms in the crystal lattice.

Additionally, defects may comprise stacking faults. Stacking faults can occur in a number of crystal structures, but the common example is in close-packed structures. A stacking fault is a one or two layer interruption in the stacking sequence, for example, if the sequence ABCABABCAB were found in an fcc (face-centered cubic) structure.

According to one non-limiting aspect of the disclosure, defects may be referred to as three dimensional macroscopic or bulk defects, such as, pores, cracks, inclusion.

According to one non-limiting aspect of the disclosure, defects may be referred to as voids, which are small regions where there are no atoms, and can be thought of as clusters of vacancies. Impurities can cluster together to form small regions of a different phase. These are often called precipitates.

Furthermore, additive manufacturing may comprise 3D printing, which refers to any of various processes used to make a three-dimensional object. In 3D printing, additive processes can be used, in which successive layers of material can be laid down under computer control. These objects can be of almost any shape or geometry, and can be produced from a 3D model or other electronic data source. A 3D printer can be a type of industrial robot. Additive manufacturing can further comprise a wider variety of techniques such as extrusion and sintering based processes.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

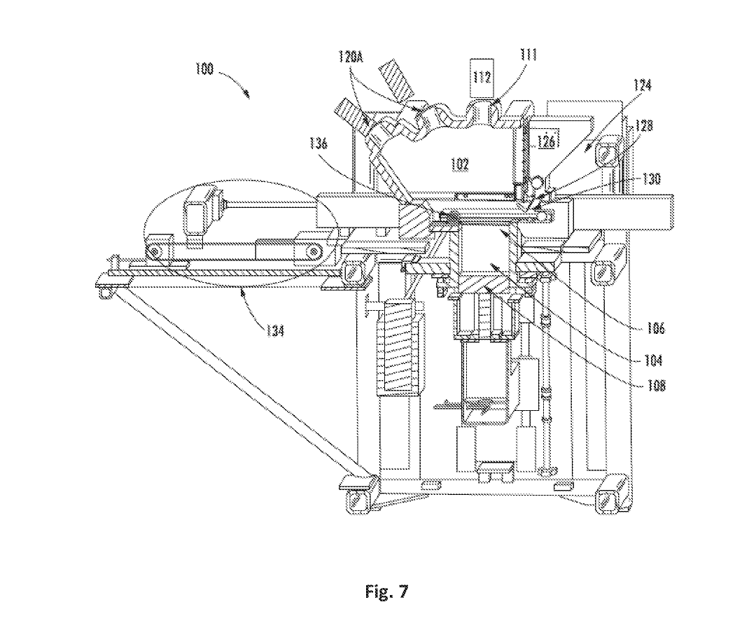

FIG. 7 is a diagram illustrating an apparatus for producing a part from a powder using a powder sintering process. The apparatus 100 can include an energy beam power meter configured to measure a power of the energy beam. The energy beam power meter can be arranged near the build surface 106 within the build chamber 102. Thus, it is possible to conduct in-situ beam calibration (e.g., adjust characteristics of the energy beam such as energy beam power) during the build process based on the actual energy beam characteristics (e.g., power) inside the build chamber 102 at or near the point where the energy beam impacts the build surface 106. For example, a controller can be configured to receive the power of the energy beam detected by the energy beam power meter, and control the energy source based on the power of the energy beam measured within the build chamber 102. In a build chamber, the window through which the energy beam passes can become contaminated due to outgassing of the powder during heating/sintering. These contaminants can absorb or divert power from the intended powder heating point with resulting variation in part properties through the depth of the part cake. Alternatively or additionally, the energy beam source can degrade over time. By measuring energy beam power in the build chamber 102, it is therefore possible to compensate for beam degradation over time either associated with conditions external to the build chamber 102 (e.g., energy beam source degradation) or internal to the build chamber 102 (e.g., contamination of window through which the energy beam passes).

The apparatus 100 can optionally include a multi-spectral imaging device 120A configured to acquire images of the build surface 106, the powder, the part, the walls of the build chamber 102 and/or the build cylinder 104. Optionally, the multi-spectral imaging device 120A can be used to acquire images of at least two of the build surface 106, the powder, the part, the walls of the build chamber 102 and/or the build cylinder 104 (e.g., as opposed to acquiring only images of a single region such as the build surface 106, for example). A multi-spectral imaging device can be arranged outside the build chamber 102 and acquire images through windows in the build chamber 102. The multi-spectral imaging device can optionally be an infrared (“IR”) imaging device. Although an IR imaging device is used in the example provided below, it should be understood that imaging devices that operate in other portions of the electromagnetic spectrum can be used. Then, using a controller, respective temperature distributions of the build surface 106, the powder, the part, the walls of the build chamber 102 and/or the build cylinder 104 can be estimated from the images acquired by the multi-spectral imaging device. This information can be used as feedback to provide real-time control the energy source (e.g., the energy source 112), the heat sources, and/or the inlet or outlet ports. For example, using the controller, it is possible to adjust characteristics (e.g., power, scan pattern, scan rate, etc.) of the energy beam. Alternatively or additionally, it is possible to energize/de-energize one or more of the heat sources. Alternatively or additionally, it is possible to open/close one or more of the inlet or outlet ports. As described above, by controlling the energy source, heat sources and/or inlet or outlet ports, it is possible to provide real-time control of the build chamber environment (e.g., temperature, temperature distribution, chemical composition, etc.) and/or the part cake conditions (e.g., temperature, temperature distribution, etc.) during the powder sintering process. This can provide the capability to adaptively control the thermal temperature time history with an increased level of detail, which can facilitate higher predictability and performance in the adaptive manufacturing process.

Alternatively or additionally, the apparatus 100 can optionally include a non-optical imaging device configured to acquire images of the powder and the part. For example, the non-optical imaging device can be an acoustic or electro-magnetic imaging device. The non-optical imaging device can be arranged outside of the build chamber and can acquire images through the walls of the build chamber, for example. The non-optical imaging device can be used to acquire three-dimensional images of the part, the powder and/or the part cake, which can be used to identify/characterize the three-dimensional properties of the part within the part cake during the powder sintering process. These images can be used to identify/characterize conditions (e.g., defects, non-uniformities, etc.) of the part during the powder sintering process. Similar to above, this information can be used as feedback to provide real-time control the energy source (e.g., the energy source 112), the heat sources and/or the inlet or outlet ports. Accordingly, this information can enable the ability to make adjustments to the energy source and/or the overall thermal control system (e.g., the build chamber environment including heat sources and/or inlet or outlet ports) to potentially mitigate properties created in earlier parts of the build process.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

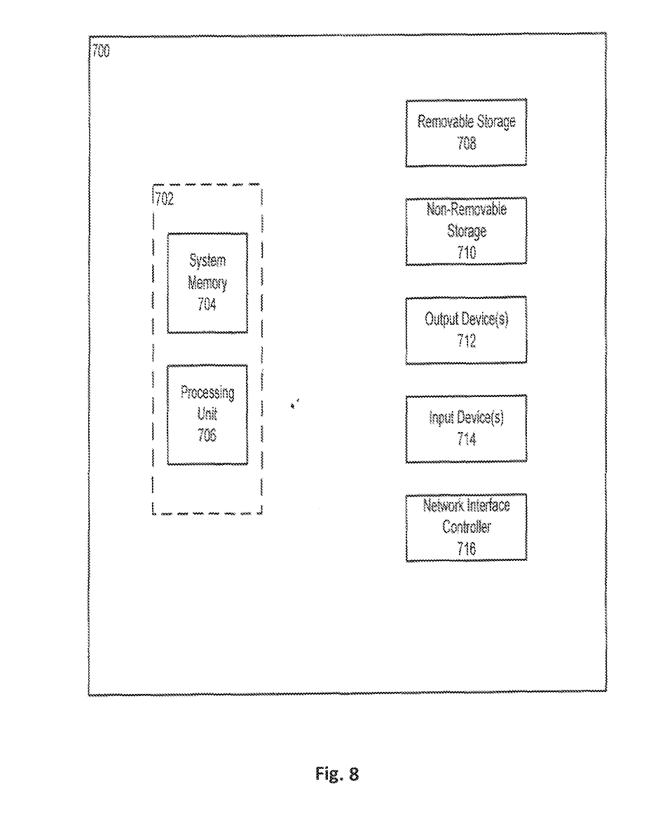

When the logical operations described herein are implemented in software, the process may execute on any type of computing architecture or platform. For example, referring to FIG. 8, an example computing device (e.g., a controller) upon which embodiments of the invention may be implemented is illustrated. The computing device 700 may include a bus or other communication mechanism for communicating information among various components of the computing device 700. In its most basic configuration, computing device 700 typically includes at least one processing unit 706 and system memory 704. Depending on the exact configuration and type of computing device, system memory 704 may be volatile (such as random access memory (RAM)), non-volatile (such as read-only memory (ROM), flash memory, etc.), or some combination of the two. This most basic configuration is illustrated in FIG. 8 by dashed line 702. The processing unit 706 may be a standard programmable processor that performs arithmetic and logic operations necessary for operation of the computing device 700.

Computing device 700 may have additional features/functionality. For example, computing device 700 may include additional storage such as removable storage 708 and non-removable storage 710 including, but not limited to, magnetic or optical disks or tapes. Computing device 700 may also contain network connection(s) 716 that allow the device to communicate with other devices. Computing device 700 may also have input device(s) 714 such as a keyboard, mouse, touch screen, etc. Output device(s) 712 such as a display, speakers, printer, etc. may also be included. The additional devices may be connected to the bus in order to facilitate communication of data among the components of the computing device 700. All these devices are well known in the art and need not be discussed at length here.

The processing unit 706 may be configured to execute program code encoded in tangible, computer-readable media. Computer-readable media refers to any media that is capable of providing data that causes the computing device 700 (i.e., a machine) to operate in a particular fashion. Various computer-readable media may be utilized to provide instructions to the processing unit 706 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 706 may execute program code stored in the system memory 704. For example, the bus may carry data to the system memory 704, from which the processing unit 706 receives and executes instructions. The data received by the system memory 704 may optionally be stored on the removable storage 708 or the non-removable storage 710 before or after execution by the processing unit 706.

Computing device 700 typically includes a variety of computer-readable media. Computer-readable media can be any available media that can be accessed by device 700 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method of detecting defects in an additive manufacturing process, comprising:
depositing a first layer of material;
depositing a second layer of material in at least partial contact with the first layer of material;
inducing a phase change between the first layer of material and the second layer of material via an energy beam;
directing an electromagnetic radiation beam to at least a portion of a subsurface interface between the first and second layers;
measuring radiation returned from the material; and
based on the measured radiation, determining a location of a refractive index gradient within the material.

2. The method of claim 1, further comprising determining whether the first and second layers are bonded to one another.

3. The method of claim 1, further comprising determining if the material contains voids, defects, or imperfections.

4. The method of claim 1, wherein inducing a phase change comprises fusing the second layer of material to the first layer of material.

5. The method of claim 1, comprising determining the refractive index gradient, wherein the refractive index gradient provides an indication of whether voids or imperfections exist within the second layer.

6. The method of claim 1, further comprising determining measurements characterizing a surface topography of the second layer based on the measured radiation.

7. The method of claim 1, further comprising correcting a void or imperfection by directing the energy beam or a second energy beam to at least a portion of the second layer based on the measured radiation.

8. The method of claim 7, wherein correcting the void or imperfection further comprises depositing a corrective layer of material.

9. The method of claim 7, wherein correcting a surface defect comprises removing material by ablation.

10. The method of claim 1, wherein the measured radiation provides an indication of backscattered light intensity from the material.

11. The method of claim 1, wherein the measured radiation provides an indication of the Doppler shift of a moving phase boundary.

12. The method of claim 1, wherein an operating parameter of the additive manufacturing process is changed based on a comparison of the measured radiation to a reference control signal.

13. An apparatus for producing a part via additive manufacturing, comprising:
a print head configured to deposit material onto a build surface of a part;
an energy source that directs energy into the deposited material;
an optical source comprising an emitter for emitting an electromagnetic radiation beam and a receiver for receiving return radiation, wherein the optical source directs the electromagnetic radiation beam toward the deposited material; and
a controller that receives measurements of the returned radiation indicating the existence of refractive index gradients within the fused material.

14. The apparatus of claim 13, wherein the energy source and optical source are contained within a housing.

15. The apparatus of claim 13, wherein the controller compares the deposited material with a reference control signal to determine the existence of deviations.

16. The apparatus of claim 13, wherein the measurements provide a surface topography of the deposited material.

17. The apparatus of claim 13, wherein the controller adapts process parameters in response to received measurements.

18. A method of detecting and correcting defects in an additive manufacturing process, comprising:
depositing material to a working surface;
directing an electromagnetic radiation beam to at least a portion of the material;
measuring radiation returned from the material;
based on the measured radiation, determining a portion of the material to be removed; and
removing the portion of the material via an energy beam.

19. The method of claim 18, wherein the portion of the material to be removed comprises a refractive index gradient.

20. The method of claim 18, wherein the energy beam is a spatially chirped beam.

21. The method of claim 18, wherein the portion of the material to be removed comprises a protrusion on the surface of the material.
